(19) United States
(12) Patent Application Publication
(10) Pub. No.: US 2013/0318307 A1
(43) Pub. Date: Nov. 28, 2013

(54) MEMORY MAPPED FETCH-AHEAD CONTROL FOR DATA CACHE ACCESSES

(71) Applicants: Alexander Rabinovitch, Kfar Yona (IL); Leonid Dubrovin, Karney Shomron (IL); Vladimir Kopilevitch, Kfar Saba (IL)

(72) Inventors: Alexander Rabinovitch, Kfar Yona (IL); Leonid Dubrovin, Karney Shomron (IL); Vladimir Kopilevitch, Kfar Saba (IL)

(21) Appl. No.: 13/478,561

(22) Filed: May 23, 2012

(51) Int. Cl. G06F 12/08

(52) U.S. Cl. 711/137; 711/E12.057

(57) ABSTRACT

An apparatus including a tag comparison logic and a fetch-ahead generation logic. The tag comparison logic may be configured to present a miss address in response to detecting a cache miss. The fetch-ahead generation logic may be configured to select between a plurality of predefined fetch ahead policies in response to a memory access request and generate one or more fetch addresses based upon the miss address and a selected fetch ahead policy.

### FIELD OF THE INVENTION

The present invention relates to memory systems generally and, more particularly, to a method and/or apparatus for memory mapped fetch-ahead control for data accesses.

### BACKGROUND OF THE INVENTION

Current video application need very effective digital signal processing (DSP) cores and very special cache subsystems. Usually data caches are used to buffer data between the DSP cores and a main memory. Main memories are usually implemented using slow double data rate (DDR) dynamic random access memory (DRAM). Conventional caching techniques fetch an additional line or lines on a cache access that caused a miss. The additional line or lines are fetched as a prediction of future accesses. By fetching the additional line or lines, the cache tries to reduce or eliminate the miss penalty of future accesses, thus reducing the overall cache degradation for the application. The fetching of an additional line or lines is often referred to as hardware Fetch Ahead (HWFA). The conventional practice is to fetch ahead sequential data (i.e., data which is accessed by the processing core using sequential addresses).

It would be desirable to implement memory mapped fetch-ahead control for data accesses.

### SUMMARY OF THE INVENTION

The present invention concerns an apparatus including a tag comparison logic and a fetch-ahead generation logic. The tag comparison logic may be configured to present a miss address in response to detecting a cache miss. The fetch-ahead generation, logic may be configured to select between a plurality of predefined fetch ahead policies in response to a memory access request and generate one or more fetch addresses based upon the miss address and a selected fetch ahead policy.

The objects, features and advantages of the present invention include providing a method and/or apparatus for memory mapped fetch-ahead control for data accesses that may (i) define several fetch ahead (FA) policies for a data cache, (ii) specify a number of FA lines to be fetched for each fetch ahead policy, (iii) specify a stride between FA lines to be fetched for each fetch ahead policy, (iv) select a fetch ahead policy to employ on a particular access based upon bits (e.g., one or more most significant bits) of an access address, and/or (v) be implemented in a digital signal processing system.

### BRIEF DESCRIPTION OF THE DRAWINGS

These and other objects, features and advantages of the present invention will be apparent from the following detailed description and the appended claims and drawings in which:

FIG. 1 is a block diagram illustrating a portion of a system in which an embodiment of the present invention may be implemented;

FIG. 2 is a block diagram illustrating a cache memory operation in accordance with an embodiment of the present invention;

FIG. 3 is a diagram illustrating an example fetch-ahead generation logic in accordance with an embodiment of the present invention; and

FIG. 4 is a flow diagram illustrating an example process in accordance with an embodiment of the present invention.

### DETAILED DESCRIPTION OF THE PREFERRED EMBODIMENTS

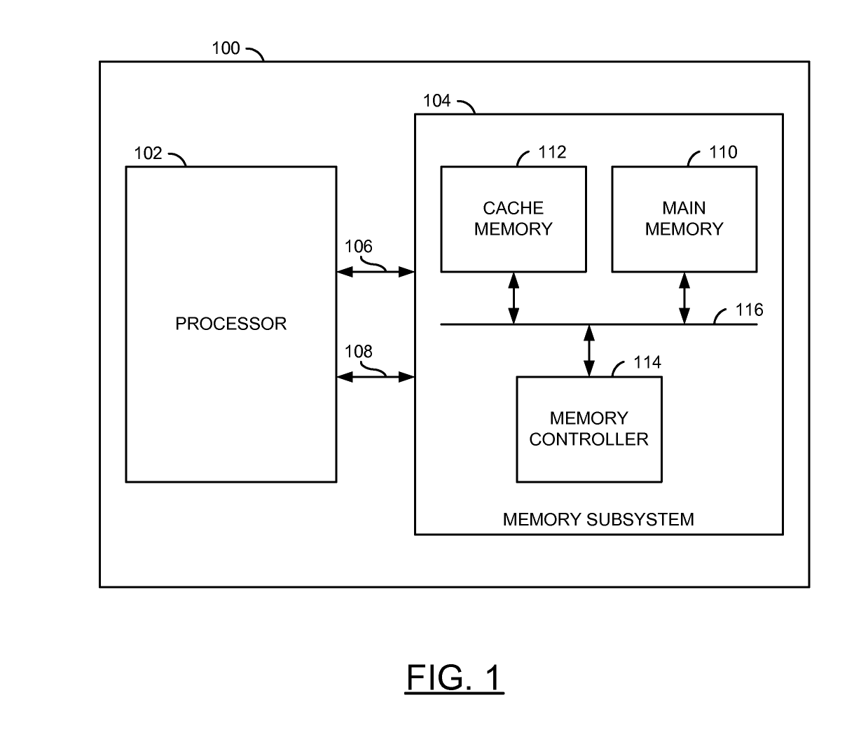

Referring to FIG. 1, a block diagram of a system 100 is shown illustrating a portion of a system in which an embodiment of the present invention may be implemented. The system 100 may be implemented, in one example, as a processor-based computer system.

In another example, the system 100 may be implemented as one or more integrated circuits. For example, the system 100 may implement a digital signal processor (DSP), video processor, or other appropriate processor-based system that meets the design criteria of a particular application.

The system 100 generally includes a block 102 and a block 104. The block 102 may implement a processor core. The block 102 may be implemented using any conventional or later-developed type or architecture of processor. The block 104 may implement a memory subsystem. In one example, a bus 106 may couple the block 102 and the block 104. In another example, a second bus 108 may also be implemented coupling the block 102 and the block 104. The bus 106 and the bus 108 may be implemented, in one example, as 512 bits wide busses. In one example, the system 100 may be configured as a video processing (e.g., editing, encoding, decoding, etc.) system. For example, the block 102 may be implemented as a digital signal processing (DSP) core configured to implement one or more video codecs.

In one example, the block 104 may comprise a block 110, a block 112, and a block 114. The block 110 may implement a main memory of the system 100. The block 112 may implement a cache memory of the system 100. The block 114 may implement a memory controller. The blocks 110, 112, and 114 may be connected together by one or more (e.g., data, address, control, etc.) busses 116. The blocks 110, 112, and 114 may also be connected to the busses 106 and 108 via the bus or busses 116. The block 110 may be implemented having any size or speed or of any conventional or later-developed type of memory. In one example, the block 110 may itself be a cache memory for a still-larger memory, including, but not limited to nonvolatile (e.g., static random access memory (SRAM), FLASH, hard disk, optical disc, etc.) storage. The block 110 may also assume any physical configuration. Irrespective of how the block 110 may be physically configured, the block 110 logically represents one or more addressable memory spaces.

The block 112 may be of any size or speed or of any conventional or later-developed type of cache memory. The block 114 may be configured to control the block 110 and the block 112. For example, the block 114 may copy or move data from the block 110 to the block 112 and vice versa, or maintain the memories in the blocks 110 and 112 through, for example, periodic refresh or backup to nonvolatile storage (not shown). The block 114 may be configured to respond to requests, issued by the block 102, to read or write data from or to the block 110. In responding to the requests, the block 114 may fulfill at least some of the requests by reading or writing data from or to the block 112 instead of the block 110.

The block 114 may establish various associations between the block 110 and the block 112. For example, the block 114 may establish the block 112 as set associative with the block 110. The set association may be of any number of “ways” (e.g., 2-way or 4-way), depending upon, for example, the desired performance of the memory subsystem 104 or the relative sizes of the block 112 and the block 110. Alternatively, the block 114 may render the block 112 as being fully associative with the block 110, in which case only one way exists. Those skilled in the relevant art would understand set and full association of cache and main memories. The architecture of properly designed memory systems, including stratified memory systems, and the manner in which cache memories may be associated with the main memories, are transparent to the system processor and computer programs that execute thereon. Those skilled in the relevant art(s) would be aware of the various schemes that exist for associating cache and main memories and, therefore, those schemes need not be described herein.

Embodiments of the present invention generally define several fetch-ahead (FA) policies for a data cache. In one example, a memory cache may include a FA policy memory that may be used to define FA policies of the memory cache (e.g., how many lines (if any) are fetched on a miss access, what is the stride between the lines fetched, etc.). With respect to an example of prefetching a 4×4 data block, a FA policy may define that on every access three additional FA accesses are generated with a distance between those accesses of 1920 bytes (e.g., the width of a high-definition (HD) video frame). In another example, a FA policy may define fifteen FA sequential accesses for fetching 1024 bytes of sequential data. In still another example, a mirror mapping of the cache memory to different pages for different FA policies may be implemented. Accesses to the mirror pages may indicate the FA policy.

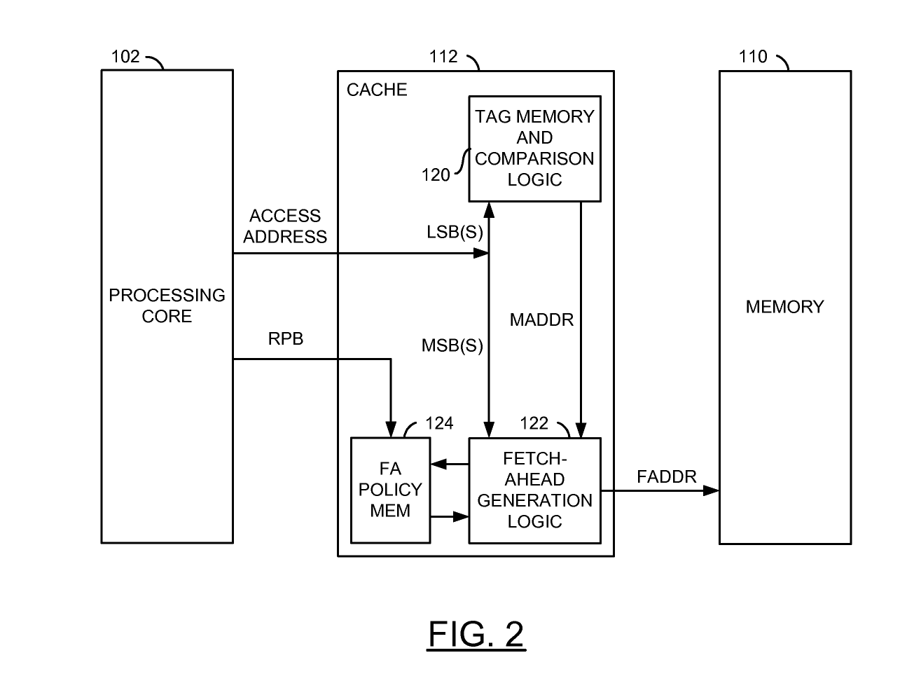

Referring to FIG. 2, a diagram is shown illustrating an example cache operation in accordance with an embodiment of the present invention. A core of the processor 102 may send an access request that includes an address (e.g., ACCESS ADDRESS) to the memory subsystem 104. The address ACCESS ADDRESS may be presented to the cache memory 112. The cache memory 112 may comprise a tag comparison logic 120, a fetch-ahead generation logic 122, and a FA policy memory 124. The FA policy memory may be implemented, in one example, as a number of registers. In another example, the FA policy memory may be implement as either a programmable or a pre-programmed (e.g., combinational logic, read only memory, etc.) look-up table (LUT).

The tag comparison logic 120 and the fetch-ahead generation logic 122 may be configured to generate a request to the memory 110 based upon a cache miss in response to the access request from the processor 102. The request to the memory 110 may include a fetch address (e.g., FADDR). The fetch-ahead generation logic 122 may be configured to generate the fetch address FADDR based upon a miss address (e.g., MADDR) provided by the tag comparison logic 120 and one or more fetch ahead policy parameters. The fetch ahead policy parameters may be selected by the fetch-ahead generation logic 122 from the FA policy memory 124 based upon the address ACCESS ADDRESS received in the request from the processor 102.

In one example, a number of least significant bits (LSBs) of the address ACCESS ADDRESS (e.g., corresponding to a main memory address to be accessed) may be used by the tag comparison logic 120 to determine whether there is a cache hit or miss and a number of most significant bits (MSBs) of the address ACCESS ADDRESS may be used by the fetch-ahead generation logic 122 to select between a number of predetermined fetch ahead policies. The parameters associated with the number of predetermined fetch ahead policies may be programmed into the FA policy memory 124 using, for example, a register programming bus (RPB) between the processor 102 and the cache 112.

In one example, a number of a selected fetch ahead policy may be indicated using the a portion of the address ACCESS ADDRESS corresponding to unused address bits. For example, mapping a 256 MB memory block from 0x0000_{—}0000h to 0x0fff_ffffh with a 32 bits wide address bus leaves four unused address bits. The four unused address bits allow the definition of sixteen different mappings and, therefore, sixteen FA policies. The sixteen FA policies may be distinguished, for example, using the most significant bits (MSBs) of the address ACCESS ADDRESS. An example of such a definition may be summarized as in the following TABLE 1:

TABLE 1

| | |
|---|---|
| FA Policy 0 | 0x0000_0000-0x0fff_ffff |
| FA Policy 1 | 0x1000_0000-0x1fff_ffff |
| . . . | . . . |
| FA Policy 15 | 0xF000_0000-0xFfff_ffff |

Such an implementation generally enables a programmer or compiler to choose the FA policy on the fly, and even for each access pointer or for the same pointer. For example, a sequence of accesses may be realized as follows:
a=0x1000_{—}1000; pointer to frame region 1 that accesses linearly;
b=0x2000_{—}2000; pointer to frame region 2 accessed with stride 128;
c=0x3000_{—}1000; pointer to frame region 1 with accesses described by For (i=0; i<256; i++) a[i]=b[i*128]+c[i*1920] (same as “a” but accessed with a stride of 1920).

Access to address (0x0000_{—}0010) may bring the memory line from address 0x0000_{—}0000-0x0000_{—}003F. The access to address (0x0000_{—}0010) may also cause fetching from the memory of the next line 0x0000_{—}0040-0x0000_{—}007F. Such an approach does not fit the needs of video applications. The nature of video codec accesses is different than the nature of accesses in standard applications. With video codecs, often the same data is accessed in different ways. For example, one part of a video algorithm may involve accesses to large two dimensional (2-D) blocks (e.g. motion estimation (ME) may accesses blocks of 256 by 256 pixels), while another part of the video algorithm may involve accesses to small 2-D blocks (e.g. motion compensation (MC) may access very small 2-D blocks, such as 4 by 4 or 2 by 2 pixels). In still another example, there may be lossless compression blocks in video algorithms that involve sequential data accesses. Often, the same data needs to be accessed in different ways. A system implementing an embodiment of the present invention may define a number of fetch ahead policies allowing the same data to be accessed in different ways by specifying a different policy for each access.

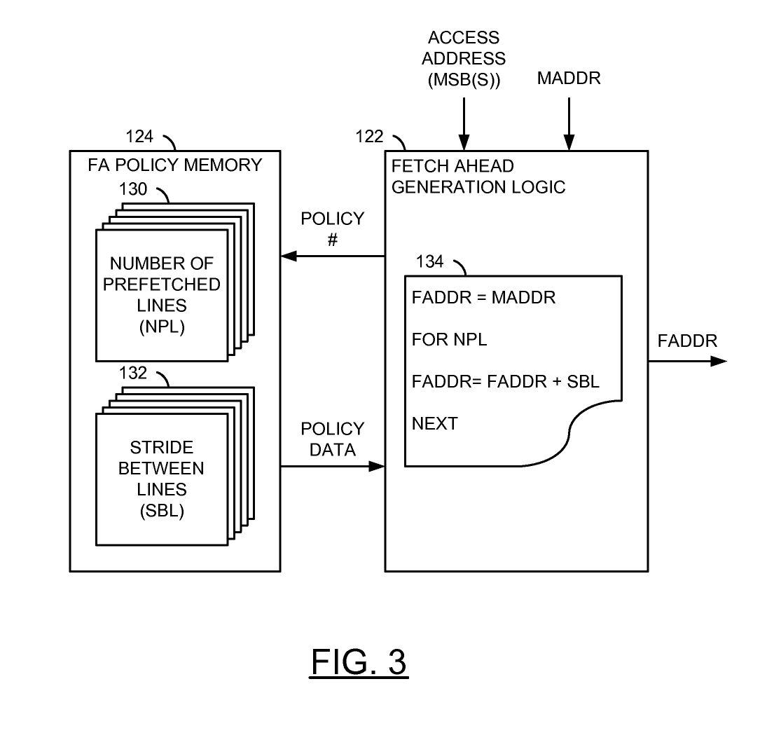

Referring to FIG. 3, a diagram is shown illustrating an example implementation of the FA policy memory 124 and the fetch-ahead generation logic 122 of FIG. 2. In one example, the FA policy memory 124 may be implemented as a number of registers 130 and a number of registers 132. Each of the registers 130 may hold a first parameter (e.g., NPL) defining a number of prefetched lines for a corresponding fetch ahead policy. Each of the registers 132 may hold a second parameter (e.g., SBL) defining a stride between prefetched lines for the corresponding fetch ahead policy. In one example, the fetch-ahead generation logic 122 may present a signal (e.g., POLICY #) to the FA policy memory 124. The signal POLICY # may identify which particular fetch ahead policy is to be implemented for the particular memory access. In one example, the signal POLICY # may be generated based upon the most significant bits of the address ACCESS ADDRESS. The registers 130 and 132 may present the appropriate parameters for the fetch ahead policy defined by the signal POLICY # to the fetch-ahead generation logic 122. In one example, the fetch-ahead generation logic 122 may implement a routine 134 for generating one or more fetch addresses (e.g., FADDR) to the main memory 110 based upon a miss address (e.g., MADDR) and the parameters received from the FA policy memory 124.

An example routine 134 may be summarized as follows: set a first fetch address equal to a miss address; for the number of prefetch lines specified by the NPL parameter of the particular fetch ahead policy set each subsequent fetch address equal to the current fetch address plus the stride between lines specified by the SPL parameter for the fetch ahead policy. The process 134 continues until the number of prefetched lines specified by the NPL parameter have been fetched. Other appropriate address generation routines may be implemented accordingly to meet the design criteria of a particular application.

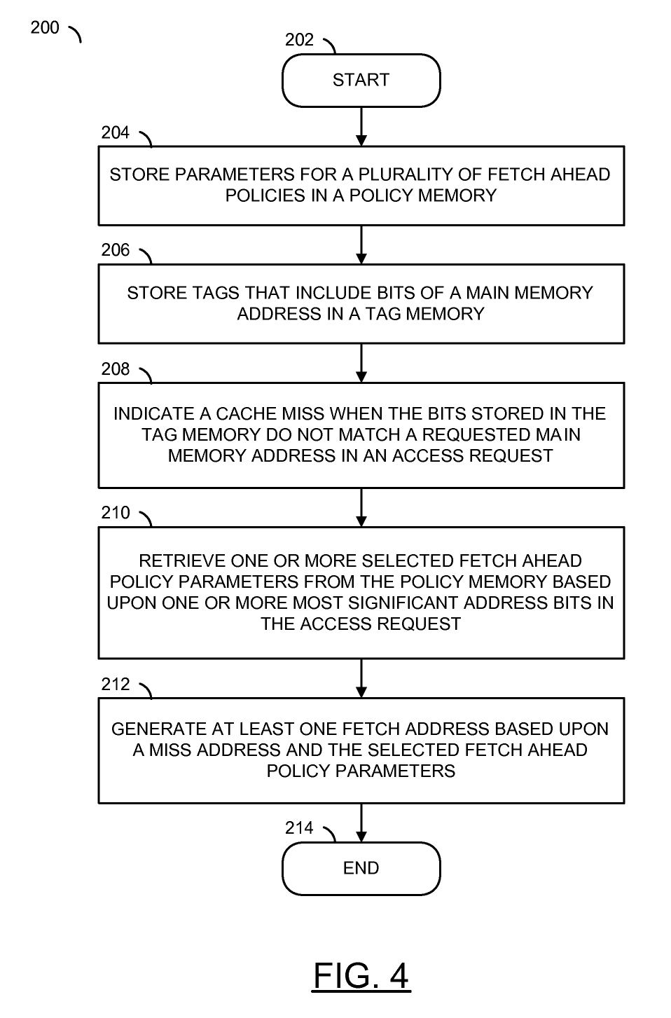

Referring to FIG. 4, a flow diagram is shown illustrating a process 200 in accordance with an embodiment of the present invention. The process (or method) 200 may comprise a start step (or state) 202, a step (or state) 204, a step (or state) 206, a step (or state) 208, a step (or state) 210, a step (or state) 212, and an end step (or state) 214. The process 200 begins in the start step 202. In the step 204, parameters for a plurality of fetch ahead policies may be stored in a policy memory. In the step 206, tags that include the bits of a main memory address are stored in a tag memory. In the step 208, a cache miss is indicated when the bits stored in the tag memory do not match a requested main memory address in an access request. In the step 210, one or more fetch ahead parameters are selected and retrieved from the policy memory based upon one or more address bits (e.g., one or more most significant bits) of the access address specified in the access request. In the step 212, at least one fetch address is generated (e.g., using fetch-ahead generation logic) based upon a miss address and the selected fetch ahead policy parameters. The process 200 ends in the end step 214.

Embodiments of the present invention generally define several fetch-ahead (FA) policies for a data cache. In one example, a memory cache may include a FA policy memory that may be used to define FA policies of the memory cache (e.g., how many lines (if any) are fetched on a miss access, what is the stride between the lines fetched, etc.). With respect to an example of prefetching a 4×4 data block, a FA policy may define that on every access three additional FA accesses are generated with a distance between those accesses of 1920 bytes (e.g., the width of a high-definition (HD) video frame). In another example, a FA policy may define fifteen FA sequential accesses for fetching 1024 bytes of sequential data. In still another example, a mirror mapping of the cache memory to different pages for different FA policies may be implemented. Accesses to the mirror pages may indicate the FA policy.

As would be apparent to those skilled in the relevant art(s), the signals illustrated in FIGS. 1-3 represent logical data flows. The logical data flows are generally representative of physical data transferred between the respective blocks by, for example, address, data, and control signals and/or busses. The system represented by the system 100 may be implemented in hardware, software or a combination of hardware and software according to the teachings of the present disclosure, as would be apparent to those skilled in the relevant art(s).

The functions performed by the diagrams may be implemented using one or more of a conventional general purpose processor, digital computer, microprocessor, microcontroller, RISC (reduced instruction set computer) processor, CISC (complex instruction set computer) processor, SIMS (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
a tag comparison logic configured to present a miss address in response to detecting a cache miss; and
a fetch-ahead generation logic configured to select between a plurality of predefined fetch ahead policies in response to a memory access request and generate one or more fetch addresses based upon the miss address and a selected fetch ahead policy.

2. The apparatus according to claim 1, wherein said fetch-ahead generation logic is configured to select between the plurality of predefined fetch ahead policies based upon a number of most significant bits (MSBs) of an access address of said memory access request.

3. The apparatus according to claim 1, wherein said plurality of predefined fetch ahead policies define a number of fetch ahead lines to be fetched.

4. The apparatus according to claim 3, wherein said plurality of predefined fetch ahead policies define a stride between the number of fetch ahead lines to be fetched.

5. The apparatus according to claim 1, wherein said tag comparison logic and said fetch-ahead generation logic are part of a cache memory that is mirror mapped to a different page for each of said plurality of predefined fetch ahead policies and a particular one of said plurality of fetch ahead policies is selected by accessing the corresponding mirror page.

6. The apparatus according to claim 1, wherein said apparatus is part of a video processing system.

7. The apparatus according to claim 6, wherein said plurality of fetch ahead policies are defined to support one or more of motion estimation, motion compensation, and lossless compression.

8. The apparatus according to claim 7, further comprising a processor core configured to implement one or more video codecs.

9. The apparatus according to claim 1, further comprising a memory accessible by said fetch-ahead generation logic, said memory configured to store parameters for said plurality of fetch ahead policies.

10. An apparatus comprising:
a memory cache;
means for presenting a miss address in response to detecting a cache miss; and
means for selecting between a plurality of predefined fetch ahead policies in response to a memory access request and generating one or more fetch addresses based upon the miss address and a selected fetch ahead policy.

11. A method of memory-mapped fetch-ahead control during memory cache accesses, said method comprising the steps of:
receiving a memory access request;
generating a miss address in response to detecting a cache miss;
selecting between a plurality of predefined fetch ahead policies in response to said memory access request; and
generating one or more fetch addresses based upon the miss address and a selected fetch ahead policy using a fetch-ahead generation logic.

12. The method according to claim 11, wherein said fetch-ahead generation logic is configured to select between a plurality of predefined fetch ahead policies based upon a number of most significant bits (MSBs) of an access address of said memory access request.

13. The method according to claim 11, wherein said plurality of predefined fetch ahead policies define a number of fetch ahead lines to be fetched.

14. The method according to claim 13, wherein said plurality of predefined fetch ahead policies define a stride between the number of fetch ahead lines to be fetched.

15. The method according to claim 11, further comprising:
mirror mapping a cache memory to a different page for each of said plurality of predefined fetch ahead policies, wherein a particular one of said plurality of fetch ahead policies is selected by accessing the corresponding mirror page.

16. The method according to claim 11, wherein said plurality of fetch-ahead policies are defined to support one or more of motion estimation, motion compensation, and lossless compression.
